(19) United States
(12) Patent Application Publication
(10) Pub. No.: US 2019/0317317 A1
(43) Pub. Date: Oct. 17, 2019

(54) CAMERA LENS AND SENSOR CLEANING TOOL

(71) Applicant: Giuseppe PETTINICCHIO, Laval (CA)

(72) Inventor: Giuseppe PETTINICCHIO, Laval (CA)

(21) Appl. No.: 16/382,801

(22) Filed: Apr. 12, 2019

Related U.S. Application Data
(60) Provisional application No. 62/656,673, filed on Apr. 12, 2018.

(51) Int. Cl. G02B 27/00; B60S 1/52; B60S 1/56; B60S 1/08

(52) U.S. Cl. CPC G02B 27/0006; B60S 1/0862; B60S 1/56; B60S 1/52

(57) ABSTRACT

A cleaning tool is adapted for cleaning a camera lens or sensor of a vehicle comprising a surface being subject to weather conditions in which coarse matter adheres to the surface. The cleaning tool comprises a body comprising a container for containing a cleaning solution, a delivery nozzle fluidly connected to the container, and a trigger for forcing the cleaning solution through the delivery nozzle to be sprayed over the surface of the sensor. The cleaning tool further comprises a blade extending from the body, the blade comprising an operating edge for sliding against the surface to remove the coarse matter from the surface, and a swabbing component housed by the body, the swabbing component being made from microfiber, chamois or an alternative type of cleaning cloth material and being adapted for polishing the surface.

### CROSS-REFERENCE TO RELATED APPLICATION

This application claims priority from U.S. provisional patent application 62/656,673 filed Apr. 12, 2018, the specification of which is hereby incorporated herein by reference in its entirety.

### BACKGROUND

### (a) Field

The subject matter of the present disclosure relates to a cleaning device, and more particularly to a cleaning device that provides convenient use of cleaning solution and other components relative to cleaning operation in a single device, that is easy to transport by a user.

### (b) Related Prior Art

Nowadays, if someone is to clean a certain object, they will most likely hold a bottle of cleaning solution, spray the cleaning solution onto the object to be cleaned, and wipe the object with a cleaning wiper until the object is clean. Now a cleaning process of a liquid crystal display (LCD) is described for example. After the LCD is sprayed with a cleaning solution, the user will generally have put down the bottle of cleaning solution to use one hand hold the LCD and with the other hand the user will wipe the LCD with a wiper. To thoroughly clean the LCD, the user may have to fetch the cleaning solution bottle again and again for spraying the cleaning solution for some more times, so the cleaning solution bottle is preferably placed close to the user. However, under such circumstances, the user must be very careful during the cleaning process not to tip the cleaning solution bottle over, so as to avoid making a mess in the working environment, or in some circumstances the user has no specific location to put down the bottle. This causes great inconvenience to the user who is trying to clean the LCD. Besides, it is quite vexing having to look for the cleaning solution bottle again and again. Furthermore, during the foregoing cleaning process, the cleaning solution will permeate into the wiper while the user wipes with the wiper, thereby allowing chemicals in the cleaning solution to make direct contact with or even injure the skin of the user's hand. Moreover, since the cleaning solution bottle and the wiper come independently, they are usually put aside separately after use. Therefore, when the next time the user wants to do the cleaning, he or she will have to spend time and effort to search for the cleaning solution bottle and the wiper respectively.

There is therefore a need for improvement in the field in the form of a device that would overcome the above-identified annoyances.

### SUMMARY

According to an embodiment, there is provided a cleaning tool for cleaning a camera lens or sensor of a vehicle, the camera lens and sensor comprising a surface being subject to weather conditions in which coarse matter adheres to the surface, the cleaning tool comprising: a body comprising: a container for containing a cleaning solution; a delivery nozzle fluidly connected to the container; and a trigger for forcing the cleaning solution through the delivery nozzle; and a blade extending from the body, the blade comprising an operating edge for sliding against the surface to remove the coarse matter from the surface, and wherein the delivery nozzle is orientated upwardly relative to a horizontal plane when the body is in an upright vertical orientation perpendicular to the horizontal plane to thereby deliver a stream of cleaning solution upwardly relative to the horizontal plane.

According to an aspect, a least a section of the operating edge of the blade has a concave shape.

According to an aspect, the orientation of the delivery nozzle is of between about ten (10) degrees and eighty (80) degrees from the horizontal plane when the cleaning tool is held in the upright position.

According to an aspect, the orientation of the delivery nozzle is of between about forty (40) and sixty (60) degrees from the horizontal when the cleaning tool is held in the upright position.

According to an aspect, the operating edge of the blade has a width and wherein the operating edge has a variable thickness along its width.

According to an aspect, the operating edge of the blade has a width and has sides and a center along its width, and wherein the thickness of the operating edge at the sides is greater than the thickness of the operating edge at the center.

According to an embodiment, there is provided a cleaning tool for cleaning a camera lens or sensor of a vehicle, the camera lens and sensor comprising a surface being subject to weather conditions in which coarse matter adheres to the surface, the cleaning tool comprising: a body comprising: a container for containing a cleaning solution; a delivery nozzle fluidly connected to the container; and a trigger for forcing the cleaning solution through the delivery nozzle to be sprayed over the surface; and a blade extending from the body, the blade comprising an operating edge having an arched-shaped section for sliding against the surface to remove the coarse matter from the surface.

According to an aspect, the arched-shaped section has a concave shape.

According to an aspect, the operating edge of the blade has a width, and wherein the operative edge has a variable thickness along its width.

According to an aspect, the operating edge has sides and a center along its width, and wherein the thickness of the operative edge at the sides is greater than the thickness of the operative edge at its center.

According to an embodiment, there is provided a cleaning tool for cleaning a camera lens or sensor of a vehicle, the camera lens and sensor comprising a surface being subject to weather conditions in which coarse matter adheres to the surface, the cleaning tool comprising: a body comprising: a container for containing a cleaning solution; a delivery nozzle fluidly connected to the container; and a trigger for forcing the cleaning solution through the delivery nozzle to be sprayed over the surface; blade extending from the body, the blade comprising an operating edge for sliding against the surface to remove the coarse matter from the surface; and a swabbing component housed by the body, the swabbing component being made from microfiber material and adapted for polishing the surface.

According to an aspect, the body further comprises an enclosed aperture in which is located the trigger, where the trigger operates between an idle position and a pressed position, and wherein the trigger in the idle position relative to the pressed position extends further in the aperture.

According to an aspect, the body comprises a front and a back, and wherein the aperture extends throughout the body between the front and the back.

According to an aspect, the delivery nozzle is distant from the trigger.

According to an aspect, the container comprises a bottom, wherein the delivery nozzle is fluidly connected to the bottom of the container, wherein the body has an upright orientation in which the cleaning solution fills the bottom of the container, and wherein the delivery nozzle delivers the cleaning solution out of the body upon the trigger being pressed, the cleaning solution being sprayed as a stream having an upward orientation when the body is in its upright orientation.

According to an aspect, the orientation of the stream is of between about ten (10) degrees and eighty (80) degrees from the horizontal when the cleaning tool is held in the upright position.

According to an aspect, the orientation of the stream is of between about forty (40) and sixty (60) degrees from the horizontal when the cleaning tool is held in the upright position.

According to an aspect, at least a section of the operating edge of the blade has a concave arched shape.

According to an aspect, the operating edge of the blade has a width and has sides and a center along its width, and wherein the thickness of the operating edge at the sides is greater than the thickness of the operating edge at the center.

According to an aspect, the cleaning tool further comprises a locking component, wherein the locking component is unlockable to displace the swabbing component between a storage position and a swabbing position.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective front view of a camera lens and sensor cleaning tool in accordance with an embodiment;

FIGS. 2A and 2B are perspective front views of embodiments of camera lens and sensor cleaning tools, with FIG. 2A depicting the camera lens and sensor cleaning tool of FIG. 1 with the chamber partially open and a swabbing component exiting partially the chamber and FIG. 2B depicting another embodiment of an camera lens and sensor cleaning tool with the swabbing component fully housed in the chamber;

FIG. 3 is a perspective side view of an exemplary car comprising sensors to be cleaned using an embodiment of the camera lens and sensor cleaning tool;

FIGS. 4A-4B are respectively perspective front and rear views of an exemplary car comprising sensors to be cleaned using an embodiment of the camera lens and sensor cleaning tool;

FIG. 5 is a is a perspective view of a camera lens and sensor cleaning tool in accordance with another embodiment;

FIG. 6 is a is a perspective view of a camera lens and sensor cleaning tool of FIG. 5 with the blade used to clean the surface of a sensor;

FIG. 7 is a perspective front view of a camera lens and sensor cleaning tool in accordance with an embodiment comprising a flip casing;

FIG. 8 is a perspective front view of a camera lens and sensor cleaning tool in accordance with another embodiment comprising a vertically sliding casing; and

FIG. 9 is a perspective front view of a camera lens and sensor cleaning tool in accordance with another embodiment comprising a horizontally sliding casing.

It will be noted that throughout the appended drawings, like features are identified by like reference numerals.

### DETAILED DESCRIPTION

For the purpose of teaching, the terms top, bottom, front, back, rear upper, lower, horizontal, vertical, etc. refer to the normal holding of the tool pointing toward the front and normal orientation of the vehicle. However, these terms are intended for relative positioning and should not be construed in a limiting manner.

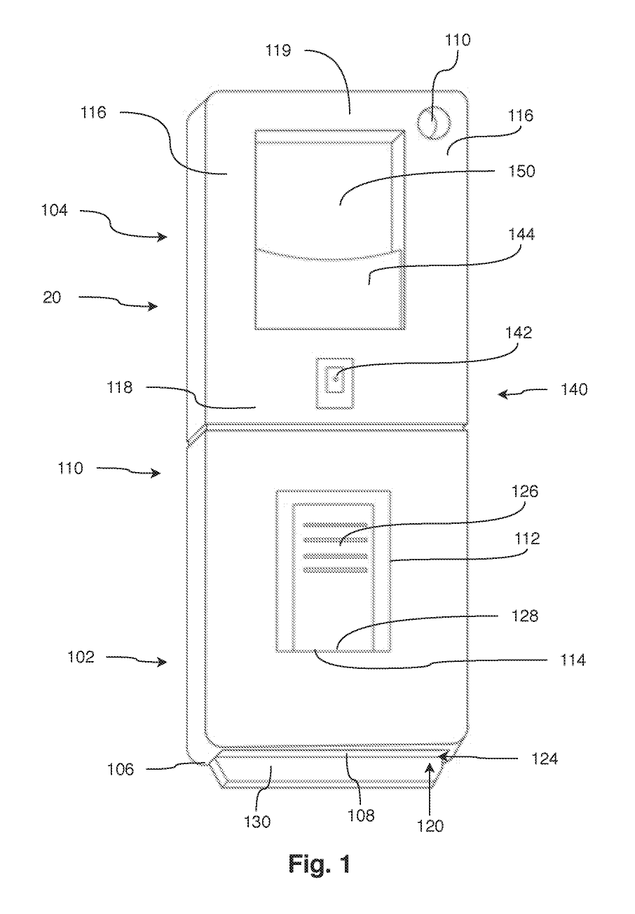

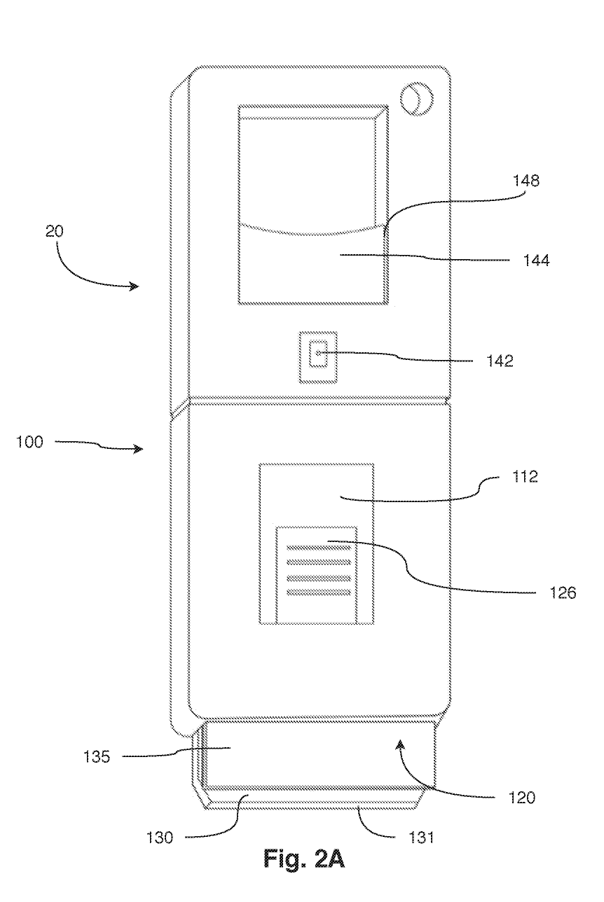

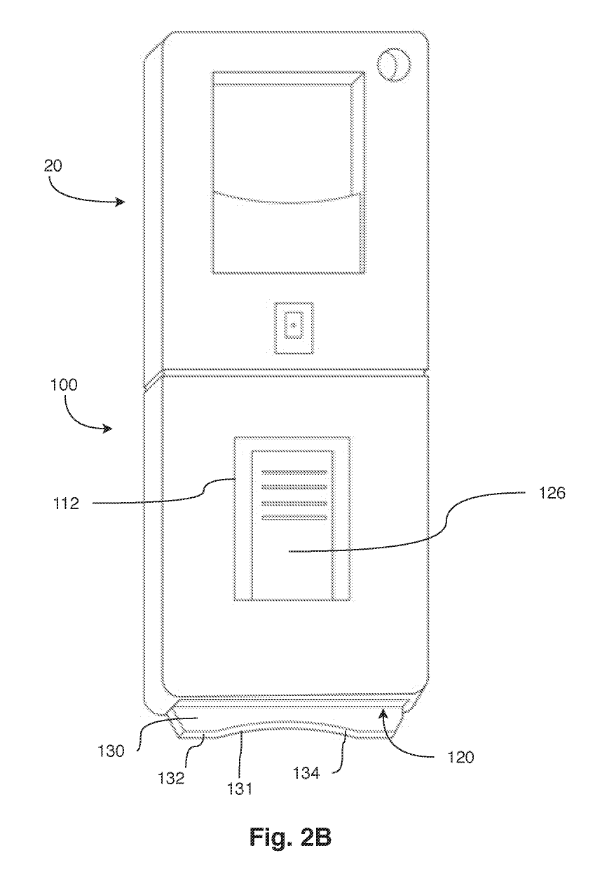

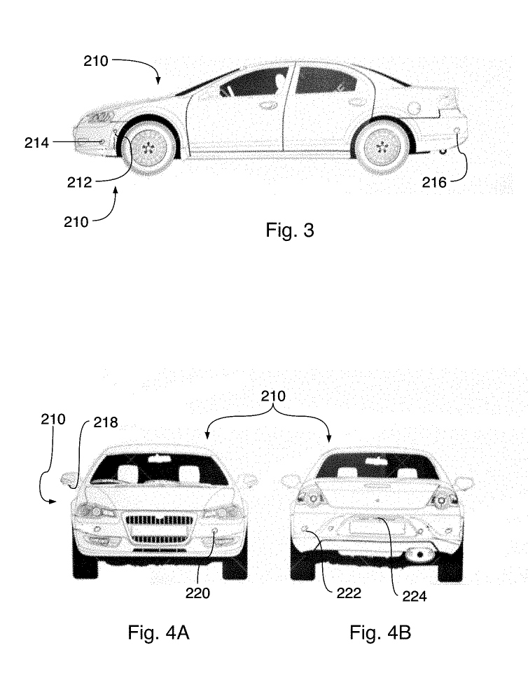

Referring now to the drawings, and more particularly to FIGS. 1 and 2A-2B, a tool 20 for cleaning camera lens and sensors of an automotive vehicle comprising a surface being subject of weather conditions is shown of FIGS. 3 and 4A-B. The tool 20 is adapted to clean the surface of sensors 210 (lens, cameras, other small optic devices and parking sensors) of a vehicle 200 (e.g., a car, a truck, a SUV, a RV, a motorcycle, a snowmobile, etc.) (See FIGS. 3 and 4A-B) subject to weather conditions. Note that the surface of the sensors 210 is normally convexly curved much like an eyeball. The tool 20 is adapted to be carried along with the keys of the vehicle 200, for example attached to a key ring.

The tool 20 comprises a body 100 having a height, a width and a depth. For portable reasons, according to one embodiment, dimensions are of about four (4) inches of height by one and a half (1.5) inches of width by about a half (0.5) of an inch of depth. The tool 20 comprises a lower section 102 and an upper section 104.

The lower section 102 ends at the bottom with a blade 130 which, according to an embodiment, consists in a rubber wiper blade for sliding against a surface to remove material from the surface. The blade 130, according to the embodiment depicted on FIG. 2A, has a trapezoidal shape with the width of a section of the trapezoid decreasing as the section is distant from the base of the trapezoid toward the edge 131, namely where the blade 130 is mounted to the body 100. Accordingly, the blade 130 has a gradient of flexibility along its height, the flexibility of portions of the blade 130 increasing as the distance of the section of the blade 130 increases relative to the bottom 106 of the body 100, with the thickness of the blade 130 decreasing accordingly to reach a minimum at its edge 131.

According to the embodiment depicted on FIG. 2B, the blade 130 has a curved edge 131 matching or substantially matching the surface shape of the sensors 210 to be cleaned. According to an embodiment, the edge 131 of the blade 130 has a concave arched shape. According to an embodiment, the edge 131 of the tool 20 has a constant thickness. According to another embodiment, the edge 131 of the tool 20 has a non-constant thickness. According to an embodiment, at least one of the arched shape and the thickness of the blade 130 at the edge 131 is symmetrical relative to a vertical plan. According to an embodiment, the thickness of the blade 130 at the edge 131 is greater at the sides of the edge 131 than at the center of the edge 131.

According to an embodiment, the edge 131 of the blade 130 comprises a central arched portion 134 and side portions 132, wherein the side portions 132 define together a relative straight plane and the central portion 134 extends less from the body 100 and it thus adapted to follow the profile of the arched-shaped lens and the flat shape of the lens case of a sensor 210 enclosing the lens. Thus, the blade 130 can contact both the case and the lens of the sensor 210 of the majority of sensors 210 used nowadays.

The lower section 102 further comprises a chamber 120 where a swabbing component 135, e.g., brush, a cloth, or a piece of cleaning material, is stored. The lower section 102 comprises an opening 108 located at the bottom 106 of the lower section 102 that communicates with the chamber 120, and a window 112 located on the front and distant from the bottom 106 of the body 100. The panel 124 is connected to an outwardly biased tongue 126 that, in place, exits partially from the chamber 120 through the window 112. The tongue 126 comprises an abutting surface 128 abutting the lower edge 114 of the window 112, preventing the tongue 126 to slide downward when in place. To exit the swabbing component 135 from the chamber 120, the user presses inwardly the tongue 126 to break off the contact between the abutting surface 128 of the tongue 126 and the lower edge 114 of the window 112; and thereby freeing the tongue 126 from hindrance preventing it to slide downward.

FIG. 2A shows tongue 126 once moved downward relative to the window 112, having sled along a groove (not shown) located in the body 100 and the chamber 120, showing a portion of the swabbing component 135 exiting from the chamber 120.

According to an embodiment, the swabbing component 135 stored in the chamber has flexibility and resilience characteristics allowing the swabbing component 135 to be pressed against a surface to be swabbed, to adapt to the surface and to revert to the original shape once removed from the contact of the surface. Accordingly, to use the swabbing component 135, the user presses the tongue 126 to free the swabbing component 135 from the chamber 120 and presses the exiting portion of the swabbing component 135 against the surface to be swabbed. Once used, the swabbing component 135 is sled back in place in the chamber 120, the tongue 126 locking the swabbing component 135 in place. According to an embodiment, the blade 130 is mounted to the panel 124, and is thereby releasable from the body 100 for use on surfaces.

Accordingly, the tongue 126 and associated structure adapted to hold or store the swabbing component 135 operate as a locking component for releasably storing the swabbing component in the body 100 and, when the tongue 126 is released from the body 100, to move the swabbing component 135 out of the body 100, between a storage position and a swabbing position, and thereby provide access to the swabbing component for its use.

According to another embodiment (not shown), a frame (not shown) extends from the panel 124 about parallel to the tongue 126, to which the swabbing component 135 is mounted. The user may extract completely the swabbing component 135 from the body 100 and use the tongue 126 as a handle.

Still referring to FIGS. 1 and 2A-2B, the upper section 104 comprises a container 140 fluidly connected to a delivery nozzle 142, i.e. a spray nozzle, adapted to delivery of a cleaning solution in a pulverized manner over the surface of a sensor 210 of the vehicle 200 (see FIGS. 3 and 4A-4B). A trigger 144, when pressed, generates a pressure forcing the delivery nozzle 142 to eject in a pulverized manner a stream of cleaning solution from the container 140 toward a tool-facing surface. According to embodiments, the trigger 144 operates on the container 140, increasing pressure in the container 140. According to another embodiment, the trigger 144 operates on the delivery nozzle 142, forcing the pulverization of the cleaning solution present in a conduit (not shown) connected to the delivery nozzle 142 through the delivery nozzle 142, and forcing new cleaning solution to take place in the conduit as pressure is released from the trigger 144.

According to an embodiment, the delivery nozzle 142 aims at an upward angle relative to the general orientation of the tool 20 when the tool 20 is held upright optimizing flow of the cleaning solution in the tool 20. That orientation of the delivery nozzle 142 allows to aim and direct the cleaning solution toward the sensing surface of sensors 210 when the sensors 210 are mounted to the vehicle 200 pointing downward, which is common configuration of sensors 210 on a vehicle 200. In use, the tool 20 can therefore be held fairly upright such that the conduit (not shown), having an end connected to the delivery nozzle 142 and another end located at the bottom of the inside the container 140, will be able to reach and deliver the cleaning solution even when there is only a small amount left in the container 140.

According to an embodiment, the upward aiming angle of the delivery nozzle 142 is between about ten (10) degrees and eighty (80) degrees relative to the horizontal when the tool 20 is held in an upright position. According to an embodiment, the upward aiming angle of the delivery nozzle 142 is between about thirty (30) degrees and seventy (70) degrees relative to the horizontal. According to an embodiment, the upward aiming angle of the delivery nozzle 142 is between about forty (40) degrees and sixty (60) degrees relative to the horizontal. According to an embodiment, the upward aiming angle of the delivery nozzle 142 is about forty-five (45) degrees relative to the horizontal.

It must be noted that the above-discussed orientation of the stream is the average orientation, aka average stream orientation, of the cleaning solution sprayed out of the delivery nozzle 142. Therefore, an upstream stream refers to a stream wherein more than fifty percent (50%) of the cleaning solution ejected trough the delivery nozzle 142 is ejected upward, above an imaginary horizontal plane, and that without excluding that a lesser portion of the cleaning solution may travel downward.

According to an embodiment, the cone of sprayed cleaning solution, aka stream of cleaning solution, exiting the delivery nozzle 142 has an angle of less than about sixty (60) degrees. According to an embodiment, the cone of sprayed cleaning solution exiting the delivery nozzle 142 has an angle of less than about forty-five (45) degrees. According to an embodiment, the cone of sprayed cleaning solution exiting the delivery nozzle 142 has an angle of about thirty (30) degrees.

For exemplary purposes, in an aiming angle of about forty-five (45) degrees, the delivery nozzle 142 permits to the user to avoid bending down or squatting when aiming at the camera or sensor 210 when the sensors 210 are, which is commonly the case, at an height corresponding to about the hip height of the user.

According to an embodiment, the cleaning solution contained in the cleaning tool 20 has a low freezing point, lower than zero degrees Celsius (0° C.) and even usually lower than minus ten degrees Celsius (−10° C.), preventing residual cleaning solution to freeze over the sensor 210 as soon as the vehicle 200 moves at a driving speed. According to an embodiment, the nature of the cleaning solution is substantially similar to windshield cleaning solutions commonly used nowadays. According to an embodiment, the cleaning solution comprises one of an anti-freeze type lens cleaner, and a mix of windshield cleaning solutions and a cleaning additive, e.g., a low freezing point soap, improving the cleaning characteristics of the windshield cleaning solution.

According to an embodiment, the cleaning solution is spayed in liquid state out of the tool 20. According to another embodiment, the cleaning solution is stored in a liquid state in the tool 20 and is transformed into a foam state when leaving the delivery nozzle 142, with the cleaning solution in the foam state having an improved adherence on the surface of the sensors 210 than in the liquid state.

Still referring to FIGS. 1 and 2A-2B, according to an embodiment, the upper section 104 comprises a passage 150 surrounded by the body 100, thereby defining an enclosed aperture, and in which is located the trigger 144. The trigger 144 in the passage 150 prevents pressure on the exterior surfaces of the body 100 to result in a pressure over the trigger 144 that would pulverize the cleaning solution unintentionally. Furthermore, the location of the trigger 144 in the passage 150 allows the user to handle the cleaning tool 20 for pulverizing cleaning solution with a thumb pressed on one side, other fingers pressing on the other side of the body to both hold the body 100, and one or more middle fingers to press the trigger 144. Thus, the trigger 144 may be pressed while the cleaning tool 20 being held using a single hand.

Operation of the trigger 144 thereby consists in pressing down the trigger 144 from its idle raised position to its pressed position to eject cleaning solution through the delivery nozzle 142, with the trigger 144 restoring its idle raised position when the pressure is removed from the trigger 144. During the operation of the trigger 144, the sides of the trigger 144 slide in channels 148 located in the side edges of the passage 150.

According to a normal mode of operation, the tool 20 is maintained in an upright orientation as depicted on FIGS. 2A-2B when pressing the trigger 144. In the upright position, the cleaning solution fills the bottom of the container 140, which eases pumping the cleaning solution from the bottom of the container 140 to the delivery nozzle 142 fluidly connected to the bottom.

According to an embodiment, the container 140 extends in walls 116 aside the passage 150 above the level of the delivery nozzle 142. The volume of the container 140 is optimized in the use of the volume of the bottom portion 118 and of the walls 116 around the passage 150.

According to an embodiment, the top portion 119 comprises a lid (not shown) to access the container 140 to refill the container 140 with cleaning solution when the level of cleaning solution in the container 140 is low.

According to another embodiment, the container 140 is not refillable and the tool 20 is therefore considered to be a consumable product.

According to an embodiment, the delivery nozzle 142 is located about the lowest portion of the container 140, under the level of the trigger 144.

According to an embodiment, the container 140 is located at least in part below the level of the delivery nozzle 142. According to an embodiment, the container 140 is located only under the level of the delivery nozzle 142, the container 140 extending down close to or about the tongue 126.

The body 100 further comprises an eyelet 110 about the top of the body 100. The eyelet 110 is adapted to pass a ring, a chain, or another linking component to secure the tool 10 to a key ring, a hook, or another appropriate device or location. The eyelet 110 passes through the body 100, offering a good resistance against tearing.

According to an embodiment (not shown), the eyelet 110 is in a projection (not shown) from the body.

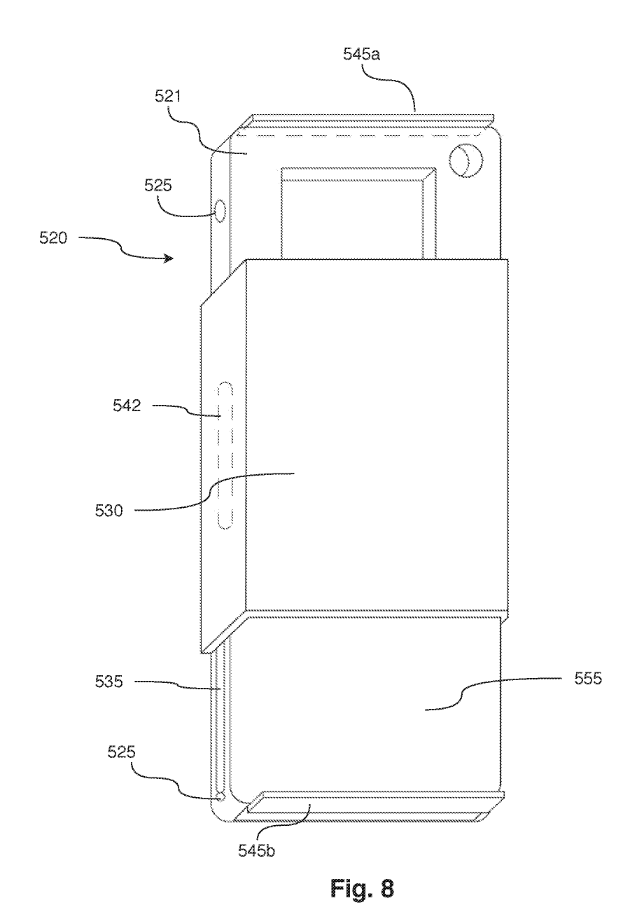

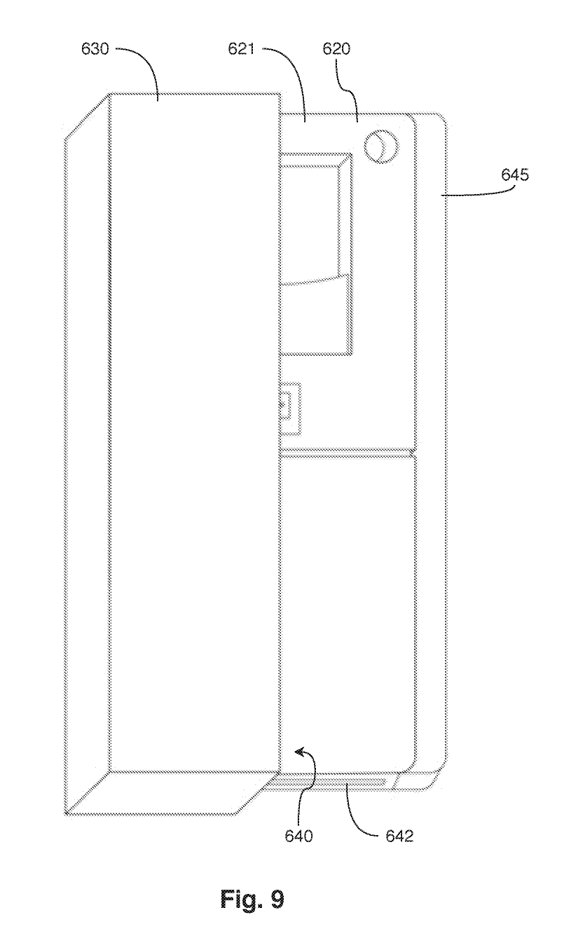

According to an embodiment (FIGS. 8 and 9), the blade 130 is located on the top or on one side of the tool 20. According to an embodiment (not shown), the blade 130 is moveable from a first position out of the body 100 ready to be used, to a second position in the body 100. A control allows to change the position of the blade 130 between the first position and the second position. According to an embodiment, the control comprises one of a slidable flap, a tongue or a toggle button.

According to an embodiment, the blade 130 is removable from the body 100. The body 100 comprises a groove of a first shape (e.g., a trapezoidal shape) that is open about at least one extremity. The blade 130 comprises a straight base of a shape that is complementary to the groove (e.g., trapezoidal shape) for the base of the blade to be sled out of the groove when needed. The shapes of the base and groove provide abutting surfaces retaining the blade 130 in place, allowing the removal of the blade 130 from the body 100 only through the open extremity of the groove.

Referring now to FIGS. 3, 4A and 4B, an exemplary vehicle 200 for using the tool 20 comprises sensors 210, comprising one or more of side cameras 212, front side sensors 214, rear side sensors 216, side mirror cameras 218, front bumper sensors 220, rear parking sensors 222 and a rear-view camera 224. One must note that the present listing of sensors 210 is intended to provide examples of sensors 210 having surfaces to be cleaned by the tool 20, rather than limiting the potential use of the tool 20.

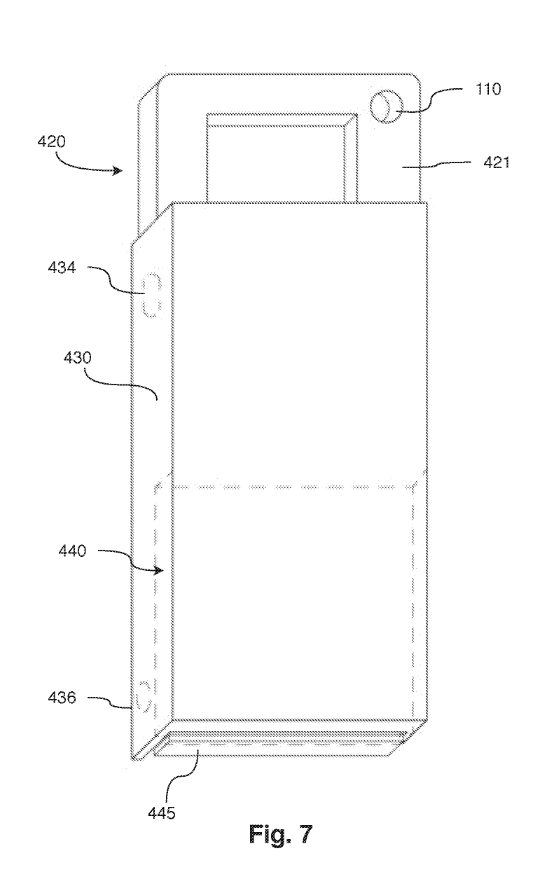

Referring now to FIG. 7. According to an embodiment, the tool 420 comprises a removable cover 430 covering at least partially the delivery nozzle 142 and the trigger 144 (not visible on FIG. 7, see FIGS. 1 and 2A-2B) when in place. To spray cleaning solution, the user must remove the cover 430 from in front of the delivery nozzle 142 and the trigger 144. According to an embodiment, the cover 430 comprises hooking surfaces 434 abutting against the sides of the body 421 to hold the cover 430 in place over the body 421. According to an embodiment, a pressure on a portion of the cover 430 away from the body 100 frees the cover 430 from the body 421. According to an embodiment, a hinge 436 links the cover to the body 421, whereby freeing the body 421 from the cover 430 resulting in spinning the cover 430 over the hinge 436.

The cover 430 further defines a chamber 440 (with some chamber walls illustrated through dashed lines on FIG. 7) limited on one side at least partially by the body 421, and on other sides by cover walls. The chamber 440 is adapted to store a swabbing component (not shown); the swabbing component being mounted at least removably to one of the chamber 440 and the body 421 and usable by the user when holding the tool 420 with the chamber 440 open. The blade 445, according to this embodiment, is protruding downward from the bottom-front portion of the body 421, usable when the cover 430 is closed, removed or spun backward.

According to an embodiment, the cover 430 is hinged to the body 421 through pins (not shown) extending inwardly from the cover 430 and entering in recesses (not shown) located on the sides of the body 421 about the bottom. Thus, to use the tool 420, the user opens the cover 430 by spinning/flipping the cover 430 about the pins, freeing the delivery nozzle 142 and at the same time providing access to the chamber 440 not closed anymore by the front of the body 421

According to an embodiment (not shown), the blade 445 is mounted to the front of the body 421, about the top of the body 421 below the eyelet 110. The blade 445 is mounted protruding horizontally frontward, closing the top of the chamber 440.

According to an embodiment (not shown), the blade 445 is mounted about a groove (not shown) to be able to remove the blade 445 from the body 421 in a similar fashion as above-discussed in relation with embodiment of FIGS. 1 and 2A-2B.

Referring now to FIG. 8. According to an embodiment, a tool 520 comprises a cover 530 that is slidable between a first position, aka a high position, shielding the delivery nozzle 142 and the trigger 144 (not visible on FIG. 8, see FIGS. 1 and 2A-2B) from contact, and a second position, aka a low position, freeing the delivery nozzle 142 and the trigger 144 for operation. For teaching purpose, FIG. 8 shows the cover 530 in an intermediate position. According to an embodiment, in the first position (the high position), the cover 530, linked to the swabbing component 555 mounted in the body 521 forces the swabbing component 555 to remain housed in the body 521, and, in the second position, forces the swabbing component 555 out of the body 521 (according to a link joining the cover 530 and a tongue or alike (see FIGS. 1 and 2A-2B). The slidable cover 530 has projections 542 (illustrated through dashes lines since inwardly oriented) that slide about grooves 535 located on exterior side walls of the body 521, the length of the grooves 535 and projections 542 limiting the course of the slidable cover 530. The course is limited between the first position and the second position. Lugs (not shown) and notches 525 located on the cover 530 and the body 521 cooperate with each other to slightly block the cover 530 in place in the first position and the second position. Thus, increased forces are required to force the lugs out of the notches 525 to move the cover 530 out of the first position and the second positions.

The cleaning tool 520 depicted on FIG. 8 has two blades 545, a top blade 545a mounted about the top of the body 521 and a bottom blade 545b mounted about the bottom of the body 521.

Referring now to FIG. 9. According to an embodiment, the tool 620 comprises a cover 630 slidable horizontally relative to the body 621. The cover 630, provides controllable access to an outwardly biased swabbing component (not shown) protruding from the bottom of the tool 620 upon a downward protrusion (now shown) linked to the swabbing component being freed from contact with the cover 630.

The body 621 comprises grooves 642 on the top wall and bottom wall along which projections (not shown) slide to move the cover 630 between a closed position and an open position. The cover 630 is configured, as discussed above, to controllably slide against and thus press against and free the downward protrusion to control position (housed or protruding) of the swabbing component.

The blade 645 of that embodiment is mounted to the side of the body 621, protruding forward the front face of the body 621, to participate in closing a chamber 640 as to be operable by the user while holding the tool 620. The blade 645 is further dismountable from the body 621 to be operated independently from the body 621.

According to an embodiment, the side wall of the body 621 on which is mounted the blade 645 comprises rivet-like components (not shown) with the body of the blade 645 comprising notches (not shown). To secure the blade 645 to the body 621, the user slides the blade 645 with the notches aligned with the rivet-like components. The blade 645 has thereby a portion squeezed between the heads of the rivet-like component and the side wall of the body 621, securing the blade 645 in place.

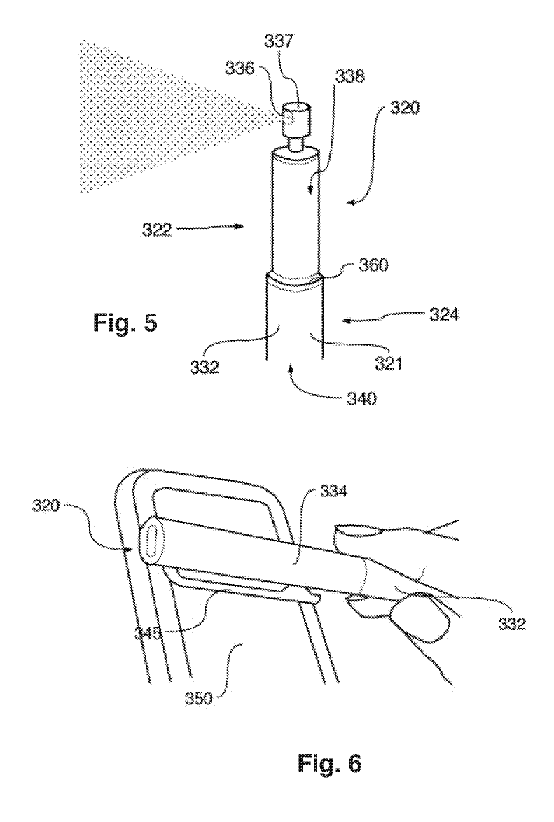

Referring now to FIGS. 5 and 6 and according to another embodiment, the tool 320 is of a cylindrical shape. The cylindrical-shaped tool 320 comprises a body 321 having a lower section 324 and an upper section 322. The lower section 324 comprises a chamber 340 accessible by the user to store swabbing component, for example a microfiber material, a chamois or an alternative type of cleaning cloth material, a broom or a brush as discussed above. According to embodiments, a bottom releasable cap 332 close of the chamber 340, with the broom or brush being mounted to the bottom cap 332 or alternatively distinct from the bottom cap 332. Alternatively, the bottom cap 332 closes the chamber 340 in which is stored the cloth.

The upper section 322 comprises a top cap 334 hiding a delivery nozzle 336 fluidly connected to a container 338 located in the body 321 of the tool 320. The container 338 contains cleaning solution. The delivery nozzle 336 comprises a trigger surface 337 on top to be depressed to push down the trigger surface 337/delivery nozzle 336 combination to force the delivery nozzle 336 to spray out cleaning solution. The delivery nozzle 336 is upwardly biased, the delivery nozzle 336 returning to the default position filling the delivery nozzle 336 with new cleaning solution to be sprayed when pressure is released from the trigger surface 337.

According to an embodiment, a blade 345 is mounted to the side of a top cap 334 to wipe the surface of an optic device 350. According to embodiments, the blade 345 is either permanently mounted to the top cap 334 or removable mounted to the top cap 334 in a before-discussed similar fashion.

The top cap comprises an eyelet (not shown) to pass a ring, a chain, or another linking component to secure the tool 320 to a key ring, a hook, or another appropriate location.

The top cap 334 and the bottom cap 332 are kept in place relative to the body 321 of the tool 320 using a combination of circumferential lips 360 and grooves (not shown) cooperating to hold the caps 332, 334 in place. One of the lips 360 and groves is located on the contour of the body 321 and the other is located on the inside contour of the cooperating cap 332, 334. Other solutions to secure releasably the caps 332, 334 to the body 321 of the tool 320 are available, and the present description intends to cover such alternatives.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A cleaning tool for cleaning a camera lens or sensor of a vehicle, the camera lens and sensor comprising a surface being subject to weather conditions in which coarse matter adheres to the surface, the cleaning tool comprising:
a body comprising:
a container for containing a cleaning solution;
a delivery nozzle fluidly connected to the container; and
a trigger for forcing the cleaning solution through the delivery nozzle; and
a blade extending from the body, the blade comprising an operating edge for sliding against the surface to remove the coarse matter from the surface, and
wherein the delivery nozzle is orientated upwardly relative to a horizontal plane when the body is in an upright vertical orientation perpendicular to the horizontal plane to thereby deliver a stream of cleaning solution upwardly relative to the horizontal plane.

2. The cleaning tool of claim 1, wherein a least a section of the operating edge of the blade has a concave shape.

3. The cleaning tool of claim 1, wherein the orientation of the delivery nozzle is of between about ten (10) degrees and eighty (80) degrees from the horizontal plane when the cleaning tool is held in the upright position.

4. The cleaning tool of claim 1, wherein the orientation of the delivery nozzle is of between about forty (40) and sixty (60) degrees from the horizontal when the cleaning tool is held in the upright position.

5. The cleaning tool of claim 1, wherein the operating edge of the blade has a width and wherein the operating edge has a variable thickness along its width.

6. The cleaning tool of claim 1, wherein the operating edge of the blade has a width and has sides and a center along its width, and wherein the thickness of the operating edge at the sides is greater than the thickness of the operating edge at the center.

7. A cleaning tool for cleaning a camera lens or sensor of a vehicle, the camera lens and sensor comprising a surface being subject to weather conditions in which coarse matter adheres to the surface, the cleaning tool comprising:
a body comprising:
a container for containing a cleaning solution;
a delivery nozzle fluidly connected to the container; and
a trigger for forcing the cleaning solution through the delivery nozzle to be sprayed over the surface; and
a blade extending from the body, the blade comprising an operating edge having an arched-shaped section for sliding against the surface to remove the coarse matter from the surface.

8. The cleaning tool of claim 7, wherein the arched-shaped section has a concave shape.

9. The cleaning tool of claim 7, wherein the operating edge of the blade has a width, and wherein the operative edge has a variable thickness along its width.

10. The cleaning tool of claim 9, wherein the operating edge has sides and a center along its width, and wherein the thickness of the operative edge at the sides is greater than the thickness of the operative edge at its center.

11. A cleaning tool for cleaning a camera lens or sensor of a vehicle, the camera lens and sensor comprising a surface being subject to weather conditions in which coarse matter adheres to the surface, the cleaning tool comprising:
a body comprising:
a container for containing a cleaning solution;
a delivery nozzle fluidly connected to the container; and
a trigger for forcing the cleaning solution through the delivery nozzle to be sprayed over the surface;
a blade extending from the body, the blade comprising an operating edge for sliding against the surface to remove the coarse matter from the surface; and
a swabbing component housed by the body, the swabbing component being made from microfiber or chamois material and adapted for polishing the surface.

12. The cleaning tool of claim 11, wherein the body further comprises an enclosed aperture in which is located the trigger, where the trigger operates between an idle position and a pressed position, and wherein the trigger in the idle position relative to the pressed position extends further in the aperture.

13. The cleaning tool of claim 12, wherein the body comprises a front and a back, and wherein the aperture extends throughout the body between the front and the back.

14. The cleaning tool of claim 11, wherein the delivery nozzle is distant from the trigger.

15. The cleaning tool of claim 11, wherein the container comprises a bottom, wherein the delivery nozzle is fluidly connected to the bottom of the container, wherein the body has an upright orientation in which the cleaning solution fills the bottom of the container, and wherein the delivery nozzle delivers the cleaning solution out of the body upon the trigger being pressed, the cleaning solution being sprayed as a stream having an upward orientation when the body is in its upright orientation.

16. The cleaning tool of claim 15, wherein the orientation of the stream is of between about ten (10) degrees and eighty (80) degrees from the horizontal when the cleaning tool is held in the upright position.

17. The cleaning tool of claim 15, wherein the orientation of the stream is of between about forty (40) and sixty (60) degrees from the horizontal when the cleaning tool is held in the upright position.

18. The cleaning tool of claim 11, wherein at least a section of the operating edge of the blade has a concave arched shape.

19. The cleaning tool of claim 11, wherein the operating edge of the blade has a width and has sides and a center along its width, and wherein the thickness of the operating edge at the sides is greater than the thickness of the operating edge at the center.

20. The cleaning tool of claim 11, further comprising a locking component, wherein the locking component is unlockable to displace the swabbing component between a storage position and a swabbing position.
